(19) United States
(12) Patent Application Publication
(10) Pub. No.: US 2009/0036020 A1
(43) Pub. Date: Feb. 5, 2009

(54) Sound Synchronized Animation Mechanism That Utilizes a Battery Powered Electromagnet

(76) Inventors: WEBB NELSON, WOODINVILLE, WA (US); SIMEON TIEFEL, STEVENSVILLE, MT (US); MARK CHERNICK, WOODINWILLE, WA (US)

Correspondence Address: LAMORTE & ASSOCIATES P.C., P.O. BOX 434, YARDLEY, PA, 19067, US

(21) Appl. No.: 12/245,673

(22) Filed: Oct. 3, 2008

Related U.S. Application Data
(63) Continuation-in-part of application No. 11/474,576, filed on Jun. 26, 2006.

(51) Int. Cl. A63H 3/28; A63H 5/00; G09F 1/04

(52) U.S. Cl. 446/297; 446/397; 40/124.03

(57) ABSTRACT

An animation system for animating parts of a novelty object. A novelty object is provided that has movable opposing parts. An electromagnet and another magnetic source are attached to the opposing parts. The electromagnet creates an electromagnetic field when activated that causes movement between the opposing parts. The movement of the opposing parts animates the novelty object. The activation of the electromagnet can be controlled by sound so that the animation is synchronized to audible signals.

### RELATED APPLICATIONS

This application is a continuation-in-part of U.S. application Ser. No. 11/474,576, entitled Sound Synchronized Animation Mechanism That Utilizes Electromagnetics, filed Jun. 26, 2006.

### BACKGROUND OF THE INVENTION

1. Field of the Invention

In general, the present invention relates to animation mechanisms used to animate parts of a toy figure or similar novelty. More particularly, the present invention relates to animation mechanisms that synchronize animation movements to sound signals.

2. Prior Art Description

Toy figures, such as dolls, are one of the earliest toys and have been in existence throughout recorded history. In this very long period of time, toy characters have been created in countless shapes and styles. Toy figures have also been fitted with many secondary features that are intended to increase the play value of the toy.

One way to increase the play value of a toy figure is to add animation to the toy figure.

Animation can be added to a toy figure in many different ways. In early times, toy figures have been turned into marionettes by tying strings to the toy figure. Toy figures have also been turned into puppets by hollowing the body of the toy figure, thereby making room for a child's hand.

In a modern toy figure, animation is typically added to the toy figure using a gearbox and actuator arms that are coupled to the gearbox. The gearbox may be powered by an electric motor. However, gearboxes are also often powered by wind-up springs or pull strings.

In many toy figures, animation mechanisms are often used to move the eyes, mouth, body and/or limbs of the figure. When animation mechanisms are used to move the mouth of a toy figure, it is typically done so to make the toy doll look as though it is talking or singing. Such toy dolls often contain voice synthesizers that broadcast words as the animation mechanism moves the mouth. In this manner, the toy figure both looks and sounds as if it were talking or singing.

When a child plays with an animated toy, it is likely that the child will touch the animated parts and try to stop the animated part from moving. This applies resistance to the designed movement of the animation mechanism. It is for this reason that traditional gearbox animation mechanisms require gearboxes that are bulky and strong. The gearboxes have to use substantial gear combinations and strong actuator arms to prevent the animation mechanism from quickly breaking when its movement is resisted. Accordingly, gearbox animation mechanisms tend to be large, expensive and heavy. When such an animation mechanism is used to animate the mouth of a toy doll, the bulky gearbox is typically located in the head of the toy figure. This makes the head of the toy figure bulky and heavy, which is a detriment for many different figure designs.

As toy figures began to be made with synthesized voices and mouth animation, toy designers began to synchronize the mouth animation with the words/sounds that were being broadcast. Such prior art animation systems are exemplified by U.S. Pat. No. 4,207,704 to Akiyama, entitled Movable Sound Producing Model, and U.S. Pat. No. 4,805,328 to Mirahem, entitled Talking Doll. In both prior art patents, a large bulky gearbox mechanism is present within the head of the toy figure. The gearbox is coupled to a controller that synchronizes the activation of the gearbox to audible sounds.

Not all toy figures have internal spaces large enough or strong enough to hold and support a bulky gearbox. In the prior art, animation has also been created using smaller electric solenoids. The activation of the solenoids required complex logic controls. Accordingly, the toy figure has to be coupled to an external computer. In this manner, all the logic circuitry and control software is kept external to the toy figure. Such prior art animated toy figures are exemplified by U.S. Pat. No. 6,572,431 to Maa, entitled Computer Controlled Talking Figure Toy With Animated Features, and U.S. Patent Application Publication No. 2005/0148279 to Maa, entitled Digitally Synchronized Animated Talking Doll.

The disadvantages of having a toy that must be coupled to an external computer are obvious. In both cited prior art examples, the toy figure can only be animated when coupled to a computer that is currently running the appropriate animation software. The toy figures, therefore, must remain in the vicinity of the computer in order to operate.

A need therefore exists for an animation mechanism that is self-contained, lightweight, small and creates animation that is synchronized to audible sounds. In this manner, sound synchronized animation can be added to small toys and lightweight toys, such as balloon toys, greeting cards and buttons, without adverse effects. Such a need is met by the present invention as described and claimed below.

### SUMMARY OF THE INVENTION

The present invention is an animation system for animating parts of a novelty item, such as a toy, greeting card or button. The system starts with a novelty item having movable parts, such as paper flap or a mouth with opposing jaw elements. A first electromagnet is attached to one part. A second electromagnet and/or fixed magnet is attached to an opposing part of the novelty item. The electromagnet creates an electromagnetic field when activated that interacts with other magnetic fields and causes movement between the parts. The movement of the parts animates the novelty item.

The animation is dependent upon the activation of one or more electromagnets. The electromagnets are preferably automatically activated by sound energy. The novelty item figure may have a speaker that broadcasts audio signals or a microphone that receives audio signals. In either scenario the audio signals are directed to a control circuit. The control circuit controls the activation and deactivation of the electromagnets. When the control circuit receives an audio signal above a certain threshold, the control circuit activates the electromagnets for the duration of that signal. Accordingly, the control circuit will activate and deactivate the electromagnets in synchronization with the peaks and lulls in the audio signal. The result is animation motion that is synchronized to the audio signals being transmitted or received.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is a schematic of an exemplary embodiment of the present invention animation system;

FIG. 2 shows a toy figure's head containing an exemplary embodiment of the present invention animation system;

FIG. 3 shows a balloon character containing an alternate embodiment of the present invention animation system;

FIG. 4 is a front perspective view of a talking button having a mouth animated by the present invention animation system;

FIG. 5 is a rear perspective view of the talking button embodiment of FIG. 4, and

FIG. 6 shows a greeting card having moving parts that are moved by the present invention animation system.

### DETAILED DESCRIPTION OF THE DRAWINGS

Although the present invention can be used to animate many objects, such as the wings of a toy bird or the tail of a toy dog, only some exemplary embodiments have been selected for illustration and discussion. The embodiments show the present invention utilized to animate the mouth of toy figure, animate the mouth on a talking button, and to animate components within a greeting card. Such exemplary embodiments are presented as the best modes contemplated for the invention but should not be considered a limitation to other embodiments within the scope of the claims.

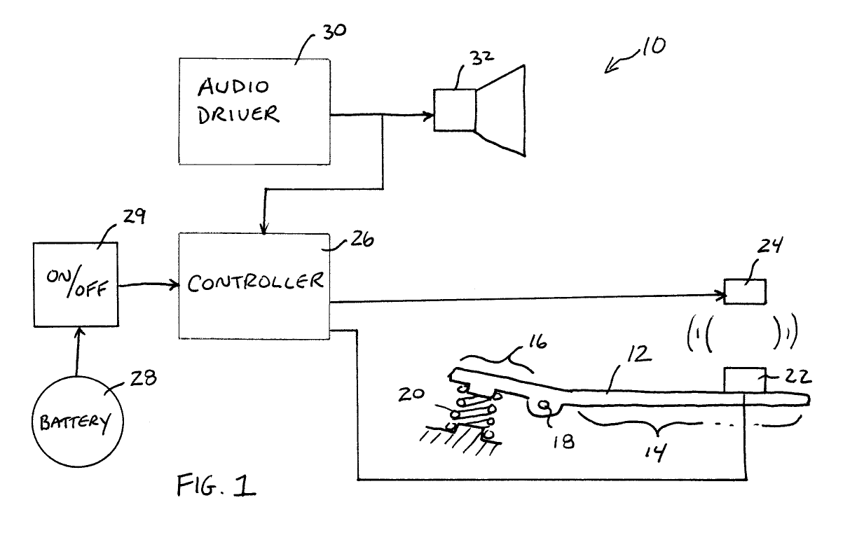

Referring to FIG. 1, there is shown a schematic of the present invention animation system 10. The animation system 10 utilizes a pivoting lever 12. The pivoting lever 12 has a first section 14, a second section 16 and a fulcrum point 18 between the first section 14 and the second section 16. A spring 20 contacts the lever 12 in the first section 14. The spring 20 supplies a bias force to the first section 14 of the lever 12. The bias force can be the spring 20 either pressing upon the lever 12 or pulling upon the lever 12. It will therefore be understood that the spring 20 biases the first section 14 of the lever 12 either downwardly or upwardly. Alternatively, the spring 20 may hold the lever 12 in a set position, wherein the spring 20 resists any upward or downward movement of the lever 12.

A first electromagnet 22 is connected to the second section 16 of the lever 12. The first electromagnet 22 is oriented so that either its positive pole or its negative pole faces upwardly. This provides either a positive or negative pole facing upwardly when the first electromagnet 22 is activated.

A second electromagnet 24 is positioned proximate the first electromagnet 22. The pole orientation of the second electromagnet 24 is preferably opposite that of the first electromagnet 22. In the shown schematic, the second electromagnet 24 is shown above the first electromagnet 22, by way of example. When the first and second electromagnets 22, 24 are not activated, each has little effect on the other. However, when the first electromagnet 22 and the second electromagnet 24 are energized, the first and second electromagnets 22, 24 will then either strongly attract or strongly repel each other. When the first electromagnet 22 and the second electromagnet 24 are energized, each creates an electromagnetic field. If the first and second electromagnets 22, 24 are energized so that similar poles of the electromagnets 22, 24 face one another, then the fields repel. Conversely, if pole of the first electromagnet 22 facing the second electromagnet 24 is oppositely charged from that of the second electromagnet 24, then the fields attract.

If the first and second electromagnets 22, 24 attract, then the second section 16 of the lever 12 pivots upwardly. Conversely, if the first and second electromagnets 22, 24 repel, then the second section 16 of the lever 12 pivots downwardly. By selectively moving the lever 12 in such a manner, the lever 12 can be caused to move up and/or down in a controlled manner.

The first and second electromagnets 22, 24 are coupled to a controller 26. The controller 26 regulates the flow of current to the first and second electromagnets 22, 24. As such, it will be understood that the controller 26 selectively turns the first and second electromagnets 22, 24 on and off, depending upon operating circumstances.

The electrical current needed to activate the first and second electromagnets 22, 24 are provided by batteries 28. An on/off switch 29 is also provided to deactivate the entire automation system 10 when desired.

An audio driver 30 is also provided. The audio driver 30 is coupled to a speaker 32. The sound synthesizer produces audio signals. The audio signals may be prerecorded in a read only memory (ROM) or can be actively recorded in a random access memory (RAM). It will be understood that if audio signals are to be interactively recorded, the animation system would also contain a microphone, which is not shown in this embodiment.

The output of the audio driver 30 is sampled by the controller 26. Whenever the controller 26 detects an audio signal over a certain threshold value, the controller 26 activates the electromagnet 24 for the duration of that signal. It will therefore be understood that when audio signals are being broadcast through the speaker 32, the first and second electromagnets 22, 24 will pulse on and off in synchronization with the signal peaks and lulls that are contained in the audio signal. The toy FIG. 36 will therefore appear to speak in a synchronized manner to the audio signals being broadcast. The controller 26 also alters the current flow to the electromagnets 22, 24 when activated. In this manner, the electromagnets repeatedly attract and repel, thereby causing continuous movement.

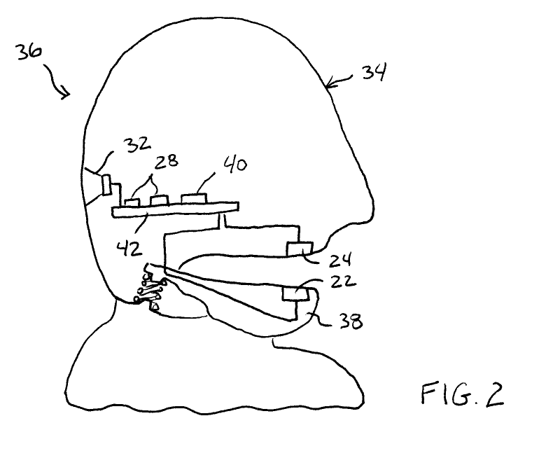

Referring to FIG. 2 in conjunction with FIG. 1, it can be seen that the present invention animation system 10 is readily adaptable to the head 34 of a toy FIG. 36. In the shown embodiment, the head 34 of the toy FIG. 36 has an articulating lower jaw 38. The articulating lower jaw 38 embodies the previously described lever 12 of the animation system 10.

The audio driver 30 and controller 26 of the animation system 10 can be designed into one or more microchips 40. The microchips are set on only a small circuit board 42. The batteries 28 and speaker 32 of the animation system 10 are also set into the same circuit board 42. The circuit board 42 is small and light weight. Accordingly, it can readily be set into the head cavity of many toy figures.

The first and second electromagnets 22, 24 can be attached to the circuit board 42 or may extend away from the circuit board 42, as is illustrated. The first and second electromagnets 22, 24 are set into the head 34 in the region that would serve as the upper and lower jaws of the mouth 44. The articulated lower jaw 38 contains the first electromagnet 22 and is positioned directly below the second electromagnet 24.

It will be understood that as the speaker 32 broadcasts words, the first and second electromagnets 22, 24 will pulse on and off. The polarities of the The articulated lower jaw 38 will therefore rise and fall in synchronization with the broadcast words. The mouth 44 movement of the toy FIG. 36 will be synchronized with the synthesized words broadcast by the toy FIG. 36.

The size and strength of the first and second electromagnets 22, 24 are directly proportional to the size and mass of the articulated lower jaw 38. A large, heavy lower jaw requires powerful electromagnets. A lightweight lower jaw does not.

Since the articulated lower jaw 38 is moved using nothing but magnetic fields, there is no gearbox or other mechanical assembly required to create the movement. As a consequence, the movement of the articulated lower jaw 38 can be resisted or stopped by the touch of a child without any damage to the animation system 10.

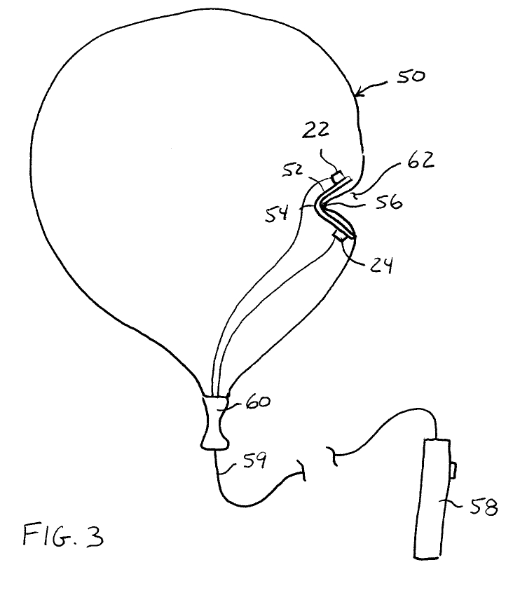

The first and second electromagnets 22, 24 can be made to be very small and very lightweight. Referring to FIG. 3, a balloon head 50 is shown. The balloon head 50 is filled with helium and is therefore lighter than air. In this embodiment, a thin, lightweight card 52 is provided. The card 52 contains a central fold 54. Both the first and second electromagnets 22, 24 are supported by the card 52 on opposite sides of the fold 54.

The card 52 is placed inside a balloon. A small dab of adhesive 56 near the central fold 54 of the card 52 is used to join the card 52 to an internal surface of the balloon head 50.

The circuitry, batteries and microphone of the animation system can be attached to the card 52. However, in the shown embodiment, these elements are contained in an assembly 58 that is external to the balloon head 50. The first and second electromagnets 22, 24 inside the balloon head 50 are connected to the external assembly 58 with lead wires 59 that pass through a plug 60 in the stem of the balloon head 50.

When the animation system is activated, the electromagnet 24 pulses in synchronization with broadcast words. As the first and second electromagnets 22, 24 pulse, the first and second electromagnets 22, 24 either attract or repel each other. This causes the card 52 to open and close. Since the card 52 is attached to the balloon head 50, the balloon head 50 appears to have a mouth 62 that is talking.

The present invention animation system can be made both small and lightweight. Thus, it can be adapted for use in helium balloons. However, the small and lightweight aspects of the present invention animation system also make the system well adapted animating generally two-dimensional objects, such as buttons, greeting cards, playing cards, printed pictures and magazine advertisements.

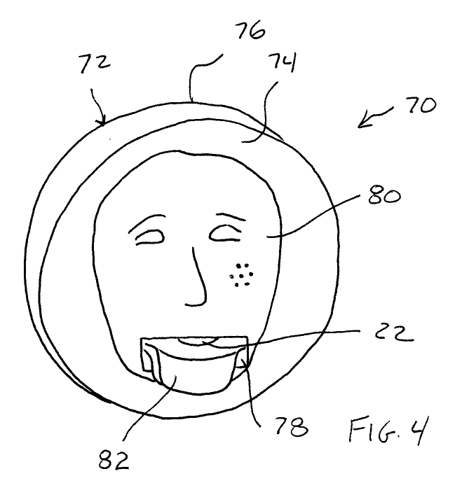

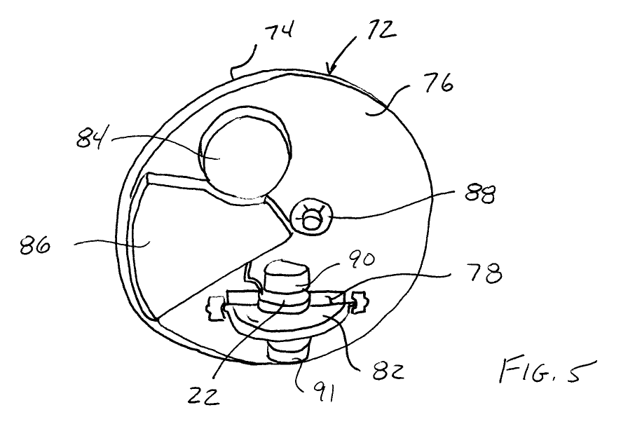

Referring to FIG. 4 in conjunction with FIG. 5, one such alternate embodiment is shown. The exemplary embodiment is configured as a talking button assembly 70. The talking button assembly 10 is comprised of a button plate 72 having a face surface 74 and a rear surface 76. The button plate 72 can be made of plastic, metal, or paperboard. An opening 78 is formed through the button plate 72. In the shown embodiment, an image 80 is printed or applied to the face surface 74 of the button plate 72. The image 80 is that of a face. The opening 78 is formed in the area of the mouth of the face.

A jaw element 82 is placed into the opening 78. The jaw element 82 is pivotably connected to the button plate 72 on the rear surface 76 of the button plate 72. The pivot connections enable the jaw element 82 to selectively move up and down within the opening 78.

An electromagnet 22 is affixed to the jaw element 82. The electromagnet 22 is powered by a button cell battery 84 that is affixed to the rear surface 76 of the button plate 72. The electromagnet 22 is connected to a electronics module 86 that contains the circuitry previously explained. A speaker 88 is provided that broadcasts audible signals, such as prerecorded words and phrases. The circuitry in the electronics module 86 pulses the electromagnet is synchronization with the audible signals being broadcast.

Two rare earth magnets 90, 92 are mounted to the rear surface 76 of the button plate 72 above and below the electromagnets 22. The rare earth magnets 90, 92 create magnetic fields. When the electromagnet 22 is activated, the magnetic field created by the electromagnet 22 is either attracted to or repulsed by the magnetic fields of the rare earth magnets 90, 91. Accordingly, the electromagnet 22 will experience forces and the jaw 82 will move. The movement of the jaw 82 in the opening 78 of the button plate 72 causes the mouth of the face on the button plate 72 to move. Since the electromagnet 22 is pulsed in synchronization with the audible signals, the jaw moves and the face image 80 on the button plate 72 appears to speak in a manner synchronized with the audible signal being broadcast.

It will be understood that buttons can be make with animated attributes other than a jaw. Using the same technology, buttons with moving eyes, moving arms, or any other feature can be produced. The example of a face with a moving mouth should be considered only exemplary.

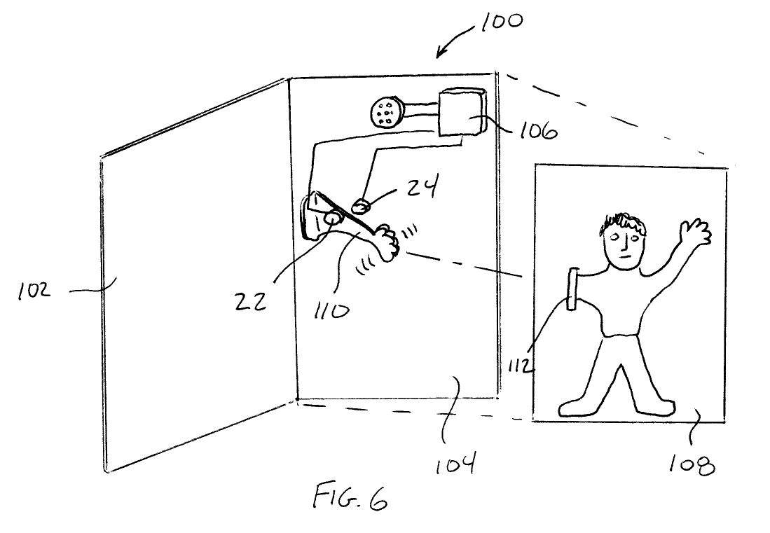

Referring to FIG. 6, another embodiment is shown. In FIG. 6, a greeting card blank 100 is shown. The greeting card blank 100 has a front cover 102 and a back cover 104. An electronics module 106 is provided. The electronics module 106 is small and thin and contains the previously described electronic components of the invention. The electronics module 106 is activated when the greeting card blank 100 is opened.

A cover card 108 is provided. The cover card attaches to the back cover 104 over the electronics module 106. The electronics module 106 is therefore interposed between the back cover 104 and the cover card 108 and cannot be seen.

A flap 110 is provided. The flap 110 is attached to the back cover 104 and extends through a slit 112 in the cover card 108. A first electromagnet 22 is attached to the flap 110. The second electromagnet 24 is mounted to the back cover 104 of the greeting card blank 100 below the card cover 108. It will therefore be understood that when the first and second electromagnets 22, 24 are activated, they either attract or repulse each other.

The card cover 108 can be printed with a person who waves, a batter who swings a bat, or any other printed pop-up used in cards. There exist countless paper pop-up configurations that have been used in cards and books. The present invention animation system provides a way to cause automated animation in any such pop-up design.

In the shown embodiment, the card cover 108 is printed with an image of a person's face. Card cover 108 may be detachable from the greeting card blank 100. Using software from a website, the person who bought the card may be able to print a picture onto the card cover 108. The card cover 108 can then be inserted back into the greeting card blank 100, wherein the flap 110 is animated when the card is open. This enables the card to be custom created for each user as well as animated by the animation system.

If will be understood that the embodiments of the present invention that have been illustrated are merely exemplary and that a person skilled in the art can make many variations to those shown embodiments. For instance, the present invention animation system can be used to animate many things other than a figure's mouth. Furthermore, although preferred, the animation provided by the invention need not be synchronized to transmitted or received sounds. All such variations, modifications and alternate embodiments are intended to be included within the scope of the present invention as defined by the appended claims.

What is claimed is:

1. An animation system for moving a feature of a novelty item, said system comprising:
a movable support forming at least part of said feature;
a first electromagnet affixed to said movable support; and
a magnetic source supported by said novelty item proximate said movable support;
wherein said first electromagnet and said magnetic source create electromagnetic fields that interacts with and cause said movable support to selectively move.

2. The system according to claim 1, wherein said magnetic source is a second electromagnet.

3. The system according to claim 1, wherein said magnetic source is at least one rare earth magnet.

4. The system according to claim 1, wherein said first electromagnet is powered by a batteries carried by said novelty device.

5. The system according to claim 2, wherein said first electromagnet and said second electromagnet are activated by a common controller.

6. The system according to claim 1, wherein said first electromagnet is selectively activated by audio signals.

7. The system according to claim 2, wherein said first electromagnet and said second electromagnet activate when an audio signals surpasses a predetermined threshold.

8. The system according to claim 1, wherein said feature is part of a character's mouth, wherein said mouth is animated by said system.

9. The system according to claim 1, wherein a magnetic field created by said first electromagnet cycles and change polarity when activated.

10. The system according to claim 1, wherein said moving element is a flap within a greeting card.

11. The system according to claim 1, wherein said novelty item is a button.

12. The system according to claim 1, wherein said moving element is affixed to an inflated balloon.

13. A system for creating animation in a novelty item, said system comprising:
two opposing elements, wherein at least one of said opposing elements is moveable relative the other and wherein movement of at least one of said opposing element causes animation in said novelty item;
a first electromagnet coupled to a first of said opposing elements;
a magnetic source coupled to a second of said opposing elements, wherein said first electromagnet and magnetic source create electromagnetic fields that interacts and causes movement between said opposing elements, therein causing animation of said novelty item.

14. The system according to claim 13, wherein said magnetic source is a second electromagnet.

15. The system according to claim 13, further including a speaker that broadcast sound signals; and a controller that activates said first electromagnet when said sound signals surpass a predetermined threshold level.

16. The system according to claim 13, wherein said novelty item has a mouth and wherein said opposing elements animate said mouth.

17. The system according to claim 13, wherein said novelty item is a greeting card with a flap, and wherein said opposing elements animate said flap.

18. The system according to claim 13, wherein said novelty item is a button, and wherein said opposing elements animate a feature visible on said button.

19. A method of creating animation in a novelty item, said method comprising the step of:
providing at least two electromagnets;
positioning said electromagnets on opposing elements that are part of said novelty object; and
selectively activating said electromagnets, wherein said electromagnets create magnetic fields that interact and cause relative movement between said opposing elements.

20. The method according to claim 19, further including the steps of:
providing an audio driver within said toy figure that produces audio signals;
providing a speaker on said toy figure that broadcasts said audio signals; and
controlling said electromagnets with said audio signals, wherein said electromagnets activate when said audio signals surpass a predetermined threshold level, therein creating animation that is at least in part synchronized with said audio signals.
